(19) United States
(12) Patent Application Publication
(10) Pub. No.: US 2004/0240243 A1
(43) Pub. Date: Dec. 2, 2004

(54) Prediction methods and circuits for operating a transistor as a rectifier

(76) Inventors: Steven D. Meyer, Mill Creek, WA (US); Hsian-Pei Yee, Mill Creek, WA (US)

Correspondence Address: EMIL CHANG, LAW OFFICES OF EMIL CHANG, 874 JASMINE DRIVE, SUNNYDALE, CA, 94086, US

(21) Appl. No.: 10/801,498

(22) Filed: Mar. 15, 2004

Related U.S. Application Data
(60) Provisional application No. 60/455,052, filed on Mar. 14, 2003.

(51) Int. Cl. H02M 7/217

(52) U.S. Cl. 363/127

(57) ABSTRACT

Circuits and methods are provided for operating a transistor as rectifier based upon the detected Vds of the transistor. In sensing the Vds voltage of the SRMOS, during positive conduction, the SRMOS body diode will conduct and the Vds of the SRMOS becomes that of a forward body diode voltage, which may, depending on the type of the device, be approximately −0.6V. If this voltage level is sensed, it may indicate that the SRMOS is turned off too early. During reverse conduction, Vds is non-existent (which is similar to a diode). In this case, the SRMOS may be turned off too late. Thus, by examining Vds, the SRMOS can be operated in such a manner so that it is turned off at an optimal point in time. Furthermore, by examining the duration of the on-time and/or off-time of said Vds voltage during a previous cycle or during the present cycle, the methods and circuits of the present invention can quickly adapt to rapidly changing duty cycles.

### PRIORITY CLAIM

This application claims priority to a provisional U.S. patent application entitled “Method of Operating a Transistor as a Synchronous Rectifier” filed on Mar. 14, 2003 having a serial No. 60/455,052. This application hereby incorporates the above-identified application in its entirety.

### BACKGROUND OF THE INVENTION

1. Field of the Invention

The present invention generally relates to electrical rectifying circuits and, in particular, to rectifying circuit that uses a transistor as a rectifier.

2. Description of the Prior Art

In power converters, synchronous rectifier MOS (SRMOS) transistors are used and operated in such a manner to perform like a diode, allowing conduction in one direction and preventing conduction in the opposite direction. The advantage with using an SRMOS transistor in the place of a diode is the higher efficiency obtainable with an SRMOS—namely the avoidance of the voltage drop across a conventional diode. This advantage becomes increasing important as greater demand and operation time is demanded from a limited power source such as batteries. In the case of a converter circuit, it becomes even more crucial that there is minimal voltage drop in converting one voltage level to another voltage level. Otherwise, a great deal of power would be lost in the conversion process itself.

Traditionally, SRMOS are controlled by several methods. Referring to FIG. 1a, a prior art converter circuit with a SRMOS is illustrated. This circuit is comprised of a first transistor 10 having gate, drain and source terminals, and the transistor is connected at one terminal to a voltage source having a particular voltage level and is connected at another terminal in series to a coil 12, and to a capacitor 16. A second transistor 18, being operated as a synchronous rectifier (SRMOS), is connected at one terminal to a node between the first transistor 10 and the coil 12 and is connected at another terminal to the common ground terminal. A pulse width modulation (PWM) control circuit 20, having a probe at the output terminal 22, detects the output voltage level. The PWM control circuit operates transistors 10 and 18 in response to the detected voltage level and causes the generation of the desired voltage level at the output terminal. Transistors 10 and 18 are controlled by a common signal and transistor 18 is connected via an inverter 14. When transistor 10 is turned on, transistor 18 is turned off. In some cases, an optional external diode is placed across transistor 10.

In this type of circuit, referring to FIG. 1b illustrating the gate voltage for transistor 10 (which is being operated as the main switch for generating the desired output voltage level) and FIG. 1c illustrating the gate voltage in operating the SRMOS (transistor 18) and FIG. 1d illustrating the current in the inductor 12, the SRMOS (transistor 18) is turned on whenever the main converter switch (transistor 10) is turned off (as indicated at 24), and the SRMOS (transistor 18) is turned off whenever the main converter switch (transistor 10) is turned on. While this is a simple arrangement, when the SRMOS is turned on, there is a large amount of reverse conduction (current flow indicated at 28) that reduces overall converter efficiency.

In yet another prior art circuit, referring to FIG. 2a, a SRMOS converter circuit using the current sense control method is illustrated. This circuit is comprised of a first transistor 30 having gate, drain and source terminals, where the transistor is connected at one terminal to a voltage source having a particular voltage level and is connected at another terminal in series to a coil 32, a shunt 34 (for current sensing), and a capacitor 36. A second transistor 38, being operated like a synchronous rectifier, is connected at one terminal to a node between the first transistor 30 and the coil 32 and is connected at the other terminal to the common ground terminal. A pulse width modulation (PWM) control circuit 40, having two is probes for current sensing across the shunt 34 and a probe at the output terminal 42, detects the current level and the output voltage level. The PWM control circuit operates transistors 30 and 38 in response to the detected voltage and current levels and causes the generation of the desired voltage level at the output terminal 42.

In this type of circuit, referring to FIG. 2b illustrating the timing of the gate voltage for transistor 30 and FIG. 2c illustrating timing of the gate voltage in operating the SRMOS (transistor 38) and FIG. 2d illustrating current flow of the inductor, in the discontinuous mode when there is reverse conduction and the inductor current starts to flow in the negative direction through the SRMOS (transistor 38), current flow is sensed through the use of the shunt 34. The control circuit 40 sensing reverse conduction turns off the SRMOS (transistor 38) to prevent further reverse conduction. However, since the shunt resistance is typically very small, it is difficult to precisely detect the timing of the zero crossing of the current. Thus, the SRMOS is turned off either before the zero crossing or after the zero crossing, rendering this an imprecise method. Because this is an imprecise method, there still may be a large amount of negative current flow (as indicated in FIG. 3d, 48). Additionally, the shunt is a resistor which consumes power as well (lossy). While the typical shunt resistor is 33 mΩ and the power consumption can be reduced by using a shunt with even smaller resistance, with a smaller shunt, there will be more reverse conduction before the negative current can be detected. Overall, this circuit is not a reliable nor efficient converter circuit.

In still yet another prior art circuit, referring to FIG. 3a, a SRMOS converter circuit using Vds sensing control method is illustrated. This circuit is comprised of a first transistor 50 having gate, drain and source terminals, where the transistor is connected at one terminal to a voltage source having a particular voltage level and is connected at another terminal in series to a coil 52, and the coil is connected to a capacitor 56. A second transistor 58, being operated like a synchronous rectifier, is connected at one terminal to a node between the first transistor 50 and the coil 52 and is connected at the other terminal to the common ground terminal. A pulse width modulation (PWM) control circuit 60, having a probe 54 for voltage sensing at a node between transistor 50 and coil 52 and a probe at the output terminal 62, detects the Vds level and the output voltage level. The PWM control circuit operates transistors 50 and 58 in response to the detected voltage levels and causes the generation of the desired voltage level at the output terminal 62.

FIG. 3b illustrates the timing of the gate voltage for transistor 50 of FIG. 3a, FIG. 3c illustrates timing of the gate voltage in operating the SRMOS (transistor 58) in view of the FIG. 3b, and FIG. 3d illustrates current flow of this circuit. In this type of circuit, in the discontinuous mode when there is reverse conduction and the inductor current starts to flow in the negative direction through the SRMOS (transistor 58), the SRMOS drain voltage (Vds) becomes positive which is sense by the control circuit 60 and the control circuit turns the SRMOS off. However, in practice, precise Vds sensing is difficult and reverse conduction occurs (as shown in FIG. 3d, 64), rendering this type of circuit unreliable and inefficient.

In a U.S. Pat., No. 6,055,170, adaptive predicted SRMOS control methods and circuits and adaptive Vds sensing SRMOS control methods and circuits are disclosed. It is discussed that a MOSFET transistor can be operated as a rectifier and is referred to as a SRMOS. During the off-state of the transistor, there is no current going from the drain terminal to the source terminal. However, there can be a voltage difference across the two terminals (Vds). If the voltage potential at the drain terminal is higher than the voltage potential at the source terminal, Vds voltage would be the difference between the two voltage potentials. If the voltage potential at the source terminal is higher than the voltage potential at the drain terminal, Vds voltage would be the forward body diode voltage of the transistor or that of an external diode if an external diode is connected across the two terminals. Furthermore, circuits and methods are disclosed for operating a transistor as rectifier based upon the detected Vds of the transistor. In sensing the Vds voltage of the SRMOS, during positive conduction, the SRMOS body diode will conduct and the Vds of the SRMOS becomes that of a forward body diode voltage, which may, depending on the type of the device, be approximately −0.6V. If this voltage level is sensed, it may indicate that the SRMOS is turned off too early. During reverse conduction, Vds is non-existent (which is similar to a diode). In this case, the SRMOS may be turned off too late. Thus, by examining Vds, the SRMOS can be operated in such a manner so that it is turned off at an optimal point in time. However, while the methods and circuits disclosed in this patent offer significant energy saving, there is inefficiency in its prediction method when there is rapid change in the SRMOS on-time duration between the previous cycle and the subsequent cycles. There, several cycles of operation is needed before the circuit can adapt to the change in the on-time duration, resulting in the undesirable condition of having large reverse SRMOS conduction.

Given the state of the art and the demand for a more efficient converter circuit, it would be desirable to have methods and circuits that can perform rectifying function and prevent the occurrence of reverse conduction through the use of a transistor.

### SUMMARY OF THE INVENTION

It is therefore an object of the present invention to provide circuits and methods for operating a transistor as a rectifier and minimizing reverse conduction by said transistor while allowing forward conduction.

It is another object of the present invention to provide circuits and methods for operating a transistor as a rectifier and minimizing reverse conduction by quickly detecting changes in a previous cycle and adapting such change in the present cycle.

Briefly, circuits and methods are provided for operating a transistor as a rectifier based upon the detected Vds of the transistor. In sensing the Vds voltage of the SRMOS during the off-state, during positive conduction (of the transistor), the SRMOS body diode conducts and the Vds of the SRMOS becomes that of a forward body diode voltage, which may, depending on the type of the device, be approximately −0.6V. If this voltage level is sensed, it may indicate that the SRMOS is turned off too early. During reverse conduction, Vds is non-existent (which is similar to a diode). In this case, the SRMOS may be turned off too late. Thus, by examining Vds, the SRMOS can be operated in such a manner so that it is turned off at an optimal point in time. Furthermore, by examining the duration of the on-time and/or off-time of said Vds voltage during a previous cycle or during the present cycle, the methods and circuits of the present invention can quickly adapt to rapidly changing duty cycles.

An advantage of the present invention is that it provides circuits and methods for operating a transistor as a rectifier and minimizing reverse conduction by said transistor while allowing forward conduction.

Another advantage of the present invention is that it provides circuits and methods for operating a transistor as a rectifier and minimizing reverse conduction by quickly detecting changes in a previous cycle and adapting such change in the present cycle.

These and other features and advantages of the present invention will become well understood upon examining the figures and reading the following detailed description of the invention.

### IN THE DRAWINGS

FIG. 1a illustrates a prior art SRMOS converter circuit using a simple switch method;

FIG. 1b illustrates the gate voltage for operating the main switch transistor of FIG. 1a;

FIG. 1c illustrates the gate voltage in operating the SRMOS of FIG. 1a;

FIG. 1d illustrates the current of the FIG. 1a circuit;

FIG. 2a shows a prior art SRMOS converter circuit using the current sense control method;

FIG. 2b illustrates the timing of the gate voltage in operating the main switch transistor of FIG. 2a;

FIG. 2c illustrates the timing of the gate voltage in operating the SRMOS of FIG. 2a;

FIG. 2d illustrates the current flow of the FIG. 2a circuit;

FIG. 3a illustrates a SRMOS converter circuit using Vds sensing control method;

FIG. 3b illustrates the timing of the gate voltage in operating the main switch transistor of FIG. 3a;

FIG. 3c illustrates the timing of the gate voltage in operating the SRMOS of FIG. 3a;

FIG. 3d illustrates the current flow of the FIG. 3a circuit;

FIG. 4a illustrates the Vds of the SRMOS in operating the SRMOS;

FIG. 4b illustrates the Vgs for operating the SRMOS in view of FIG. 4a;

FIG. 4c illustrates the reference voltage, Vref, in operating the SRMOS in view of FIG. 4a;

FIG. 5a illustrates Vramp and Vref of the preferred method showing the upward adjustment of Vref;

FIG. 5b illustrates Vgs of the SRMOS in relation with the intersection of Vramp and Vref of FIG. 5a;

FIG. 6a illustrates the Vds of the SRMOS during a rapidly changing duty cycle scenario;

FIG. 6b illustrates the Vgs for operating the SRMOS during a rapidly changing duty cycle scenario;

FIG. 6c illustrates the current during the rapidly changing duty cycle scenario;

FIG. 7a illustrates the Vds of the SRMOS of the preferred methods of the present invention;

FIG. 7b illustrates the Vgs for operating the SRMOS of the preferred methods of the present invention;

FIG. 7c illustrates the current during the rapidly changing duty cycle scenario while using the preferred method of the present invention;

FIG. 8 illustrates an embodiment for the control circuit to control the SRMOS; and

FIGS. 9-11 illustrate applications of the present invention in converter circuits.

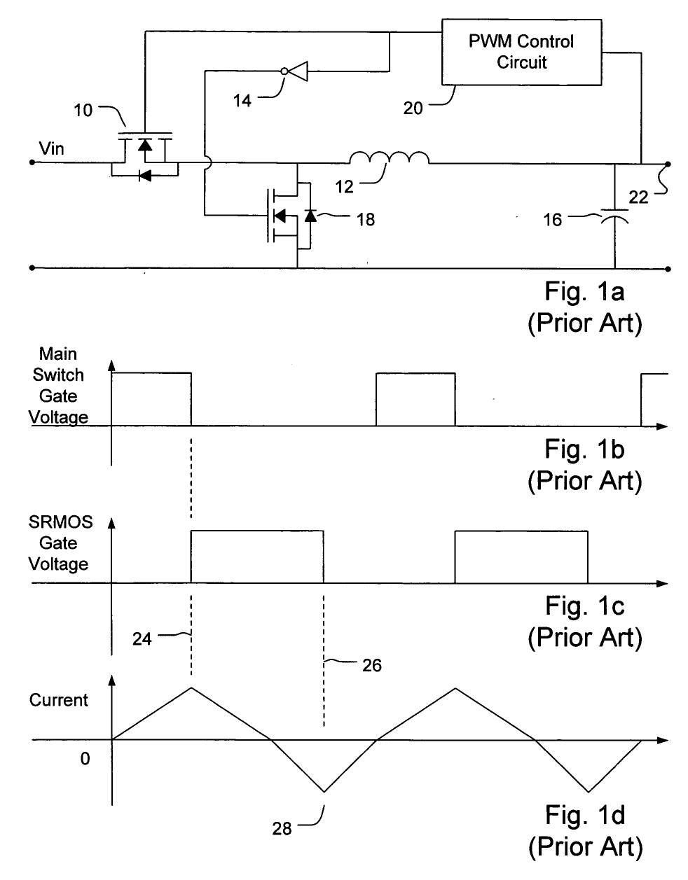

### DETAILED DESCRIPTION OF THE PREFERRED EMBODIMENTS

In presently preferred embodiments of the present invention, adaptive predicted SRMOS control methods and circuits and adaptive Vds sensing SRMOS control methods and circuits that can quickly adapt to change in Vds on-time duration are disclosed. By using these embodiments, reverse conduction is significantly reduced or even eliminated. In these methods, a reference voltage is provided and adjusted so that the SRMOS is turned off optimally when there is very short body diode conduction and no reverse conduction.

A MOSFET transistor operated as a rectifier is referred to as a SRMOS. During the off-state of the transistor, there is no current going from the drain terminal to the source terminal. However, there can be a voltage difference across the two terminals (Vds). If the voltage potential at the drain terminal is higher than the voltage potential at the source terminal, Vds voltage would be the difference between the two voltage potentials. If the voltage potential at the source terminal is higher than the voltage potential at the drain terminal, Vds voltage would be the forward body diode voltage of the transistor or that of an external diode if an external diode is connected across the two terminals.

More specifically, in sensing the Vds voltage of the SRMOS, during positive conduction (current going from source to drain), the SRMOS body diode will conduct and the Vds of the SRMOS becomes that of a forward body diode voltage of the transistor or of that of a connected external diode, which may, depending on the type of the device, be approximately −0.6V. If this voltage level is sensed, it may indicate that the SRMOS is turned off too early. During reverse conduction (current going from drain to source), Vds is near-zero. In this case, the SRMOS may be turned off too late. Thus, by examining Vds, the SRMOS can be operated in such a manner so that it is turned off at an optimal point in time.

A reference voltage for determining the timing in turning off the SRMOS is provided to accurately gauge the turn-off time for the SRMOS. The reference voltage can be provided by using a capacitor voltage where the capacitor voltage is increased to delay the SRMOS turn-off time when a Vds forward body diode voltage is detected and the capacitor voltage is decreased to turn off the SRMOS earlier in time when no Vds forward body diode voltage is detected or the duration of a detected forward body diode voltage is shorter than a predefined time period.

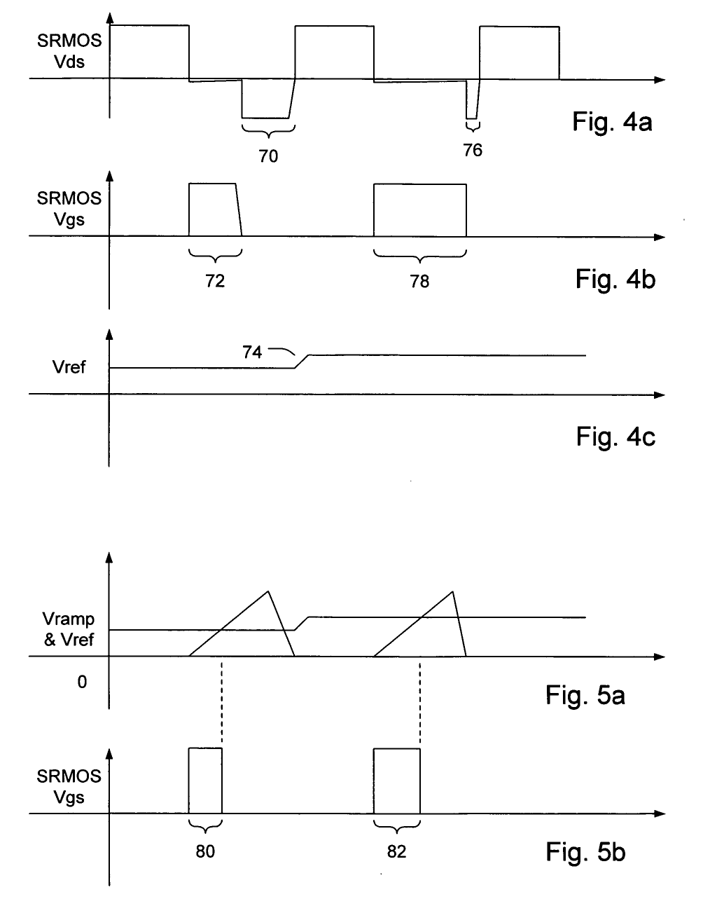

Referring to FIGS. 4a, 4b, and 4c, FIG. 4a illustrates Vds of the SRMOS, FIG. 4b illustrates the Vgs in operating the SRMOS, and FIG. 4c illustrates reference voltage, Vref. Referring to FIGS. 4a, 4b and 4c, the SRMOS is turned off too early in time (by applying Vgs as indicated at 72) such that a diode conduction (as indicated at 70) occurs (Vds approximately equals to the forward body diode voltage). When the reference voltage is adjusted upwards (as indicated at 74), the SRMOS is turned off at a later point in time (as indicated at 78), resulting in minimal diode conduction 76.

In determining the point in time to turn off the SRMOS, in one method the reference voltage is compared against a periodic ramp voltage (Vramp). When Vramp exceeds Vref, a signal is generated to turn off the SRMOS. The ramp voltage can be generated in one of several ways. It can be generated as a function of the PWM signal, the Vds signal of the SRMOS, or in other manners.

In using a generated or PWM ramp voltage in conjunction with the reference voltage, a time-based, predicted SRMOS turn off signal can be generated where this signal is based upon the previous SRMOS timing. If the converter duty cycle quickly changes, a few cycle is required to adjust Vref in relation with Vramp for turning off the SRMOS. FIG. 5a illustrates Vramp and Vref showing the upward adjustment of Vref. FIG. 5b illustrates the Vgs of the SRMOS in relation with the intersection of Vramp and Vref of FIG. 5a. As Vref is upwardly adjusted on Vramp, Vgs is prolonged and the SRMOS on-time is increased (82), and as Vref is downwardly adjusted on Vramp, Vgs is shortened and the SRMOS on-time is decreased (80).

Methods for Reacting to Rapidly Changing SRMOS Duty Cycle

As described by in the above paragraph and illustrated by FIGS. 4a-4c, to successfully control a SRMOS as a diode is to allow forward current conduct through the SRMOS and turning off the SRMOS to allow the MOSFET body diode to conduct for a small period of time before the SRMOS Vds reverses and prevents reverse current conduction. Whenever a longer than desired body diode conduction is sensed (FIG. 4a, 70), the SRMOS on-time is increased in duration from a previous cycle (FIG. 4b, 72) to a present cycle (FIG. 4b, 78) and the body diode conducts for a shorter duration (FIG. 4a, 76). When the body diode conduction is shorter than the desired duration, the SRMOS on-time is then decreased in the next cycle. This process is continuous, attempting to maintain the desired SRMOS on-time. This method is also referred to as prediction, since it turns off the SRMOS before the current going through the SRMOS is reversed using previous timing information.

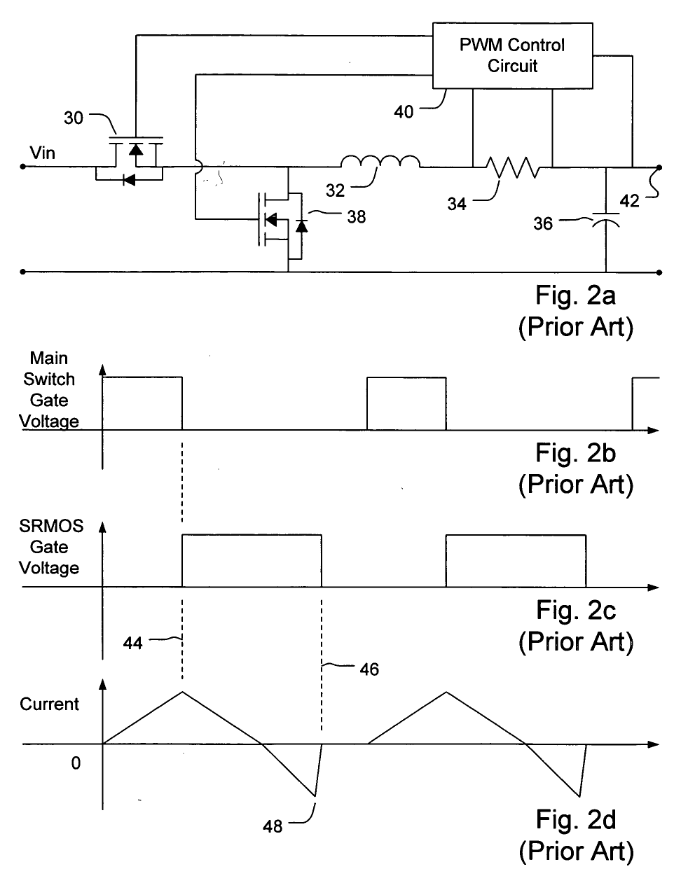

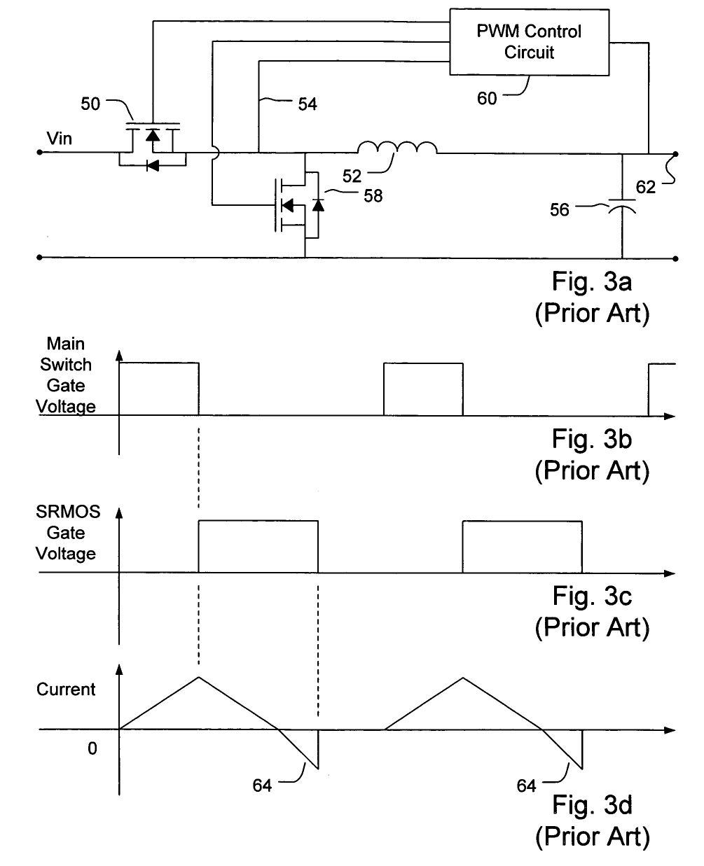

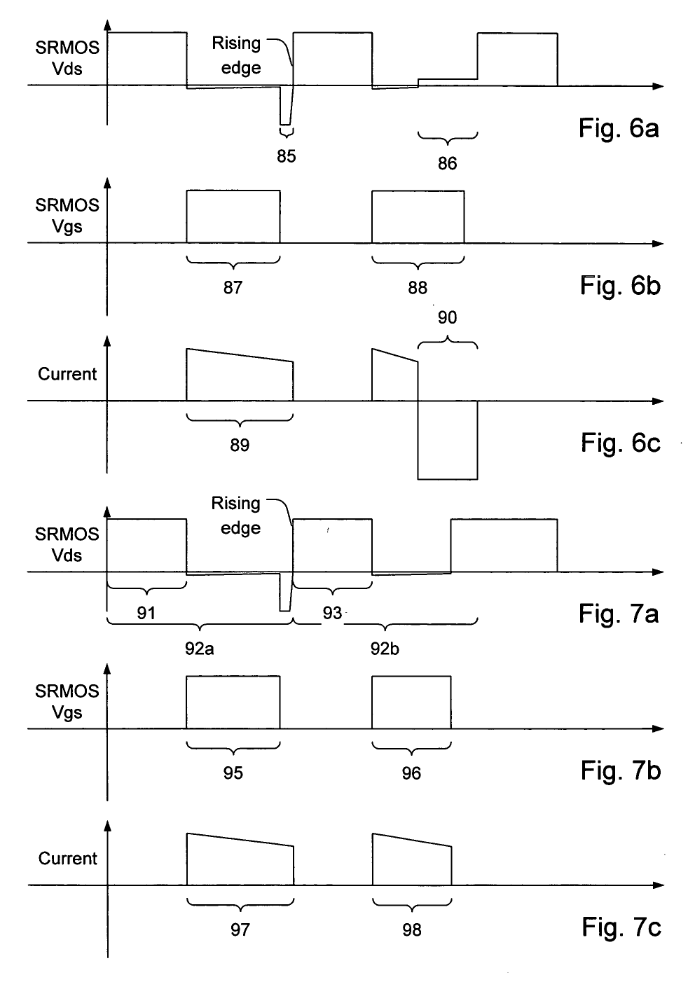

Prediction methods have a potential problem when there is a rapid change in the duration of the on-time of the Vds from a previous cycle to the present cycle. As illustrated in FIGS. 6a-6c, in a rapid change situation, in a previous cycle, the SRMOS is maintained in the on-state for a duration as indicated at FIG. 2b, 87, such that the body diode conduction time (timing difference between falling edge of Vgs and the rising edge of Vds) is at or near the desired duration (as indicated at FIG. 6a, 85). Furthermore, there is no reverse conduction experienced in the previous cycle (FIG. 6b, 87).

However, in a rapid change situation, in the present cycle, Vds attempts to go positive (FIG. 6a, 86) at a much earlier point in time than in the previous cycle (the rapid change). Since the SRMOS on-time or turn-off time is based on the previous cycle(s) (as indicated at FIG. 6b, 88), a large reverse SRMOS conduction current occurs (as indicated at FIG. 6c, 90) and the Vds voltage is held for reverse conduction (FIG. 6a, 86). This is an undesirable situation.

The methods provided in the present invention provide solutions to this rapidly changing duty cycle issue. Since every on-time of SRMOS is proceeded with the off-time of the SRMOS. The duration of the SRMOS on-time (or off-time) can be measured. If a change in the SRMOS on-time (or off-time) is detected from the previous cycle(s) or even in the present cycle, the on-time (and/or off-time) of the SRMOS can be immediately adjusted for the present cycle. In short, the duration of the on-time and off-time of the previous cycle(s) can be used to adjust the duration of the on-time and off-time of the present cycle. Furthermore, the duration of the on-time of the present cycle can be used to adjust the off-time of the present cycle given; this is particularly the case where the period of the duty cycle is fixed (which is most of the cases).

Referring to FIGS. 7a-7c, here, the SRMOS is being switched at a constant frequency, thus the duration of the previous cycle (FIG. 7a, 92a) is the same or similar to the duration of the present cycle (FIG. 7a, 92b). The present SRMOS off-time (FIG. 7a, 93) can be compared with the previous SRMOS off-time (FIG. 7a, 91). If the present SRMOS off-time (FIG. 7a, 93) duration is longer than the previous SRMOS off-time duration, the present cycle SRMOS on-time duration (FIG. 7b, 96) should be shortened by a similar amount from the previous SRMOS on-time duration (FIG. 7b, 95). Likewise, if the present SRMOS off-time is shorter than the previous SRMOS off-time, then the present cycle SRMOS on-time can be increased by a similar amount from the previous SRMOS on-time. Complementary SRMOS control can also be achieved by a similar method, where the increase of on-time of one SRMOS is used to decrease the on-time of the complementary SRMOS, or vise versa.

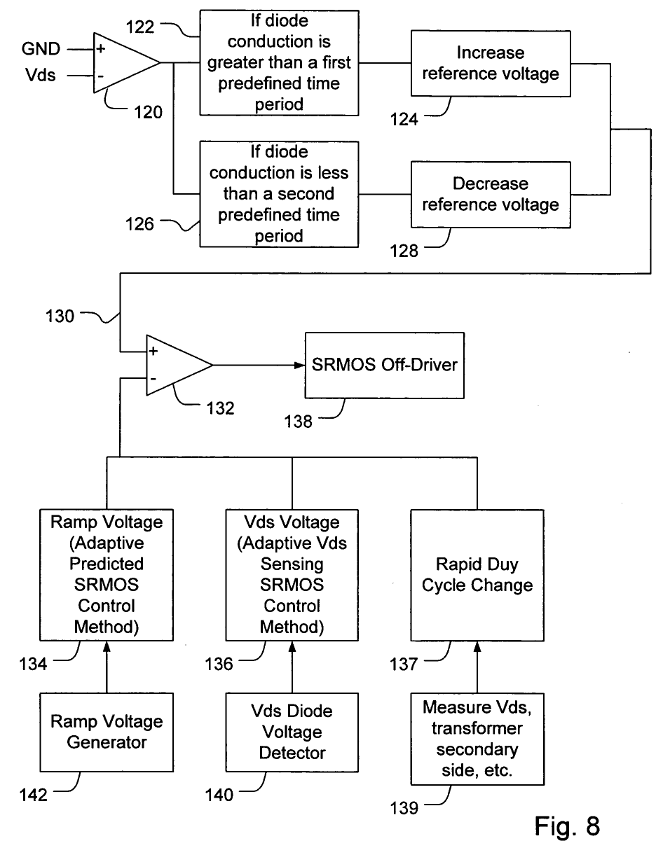

FIG. 8 illustrates one embodiment of the PWM control circuit for the present invention. A comparator 120 compares the detected Vds and ground to determine the existence of Vds at the level of a forward diode voltage potential. If Vds equals the forward body diode voltage for a duration longer than a first predefined time period (122), the reference voltage described above (Vref) is increased (124). If Vds equals the forward body diode voltage for a duration less than a second predefined time period (126), the reference voltage is decreased (128). Vref 130 is then compared to another signal at comparator 132. The other signal, depending on the embodiment, can be from one of several possible methods. In the adaptive, predicted SRMOS control method as described above, there is a ramp voltage Vramp (as described by 134 and 142) and Vramp is used as an input to the comparator 132. In the adaptive Vds sensing SRMOS control method described above, Vds is used as an input to the comparator 132 (as described by 136 and 140). In either case, if Vref equals to the provided signal (either Vramp or Vds), a signal is provided to the Off-Driver 138 for the SRMOS to turn off the SRMOS.

In yet for the rapid duty cycle change scenario 137, Vds of the SRMOS (present cycle and/or previous cycle(s)) is measured and compared to the Vds of the previous cycle or the period of the cycle in determining whether the present cycle or subsequent cycle on-time should be adjusted. For example, if the measured Vds of the SRMOS of the previous cycle has a change in its duration (either on-time or off-time), the preferred embodiments of the present invention would detect such change in duration and react immediately to it by changing the Vds (on-time and off-time) for the subsequent cycle. Furthermore, it can also change the Vds off-time for the current cycle (or on-time if duty cycle starts with off-time). Note that other than measuring the Vds, a number of other signals can also be measured in lieu of Vds. For example, the secondary side of the transformer can be measured instead of Vds. Other signals reflective of Vds or the secondary side of the transformer can be used as well. Collectively these signals (Vds, secondary side of the transformer, etc.) are referred to as Vds indicator signals and the on-time and/or off-time thereof.

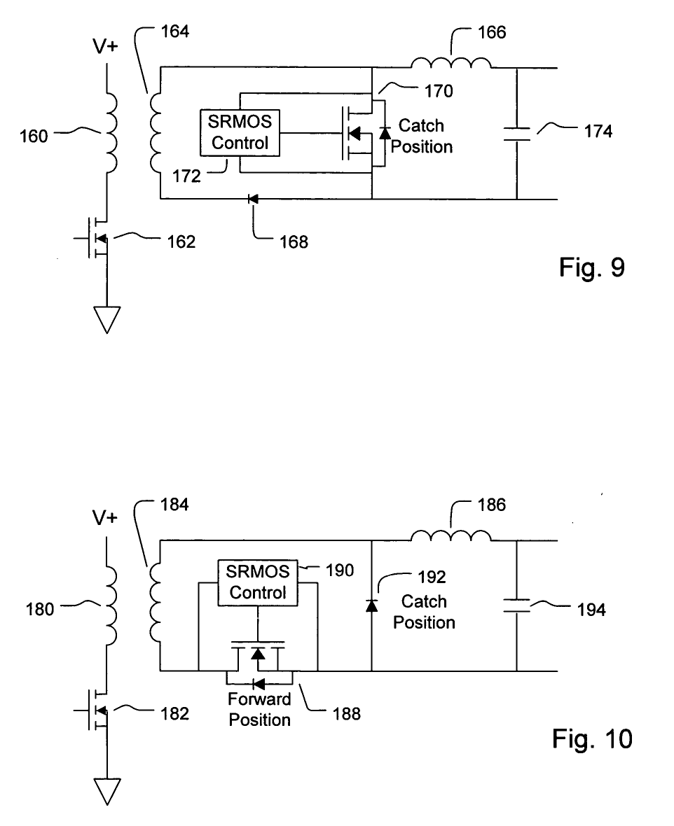

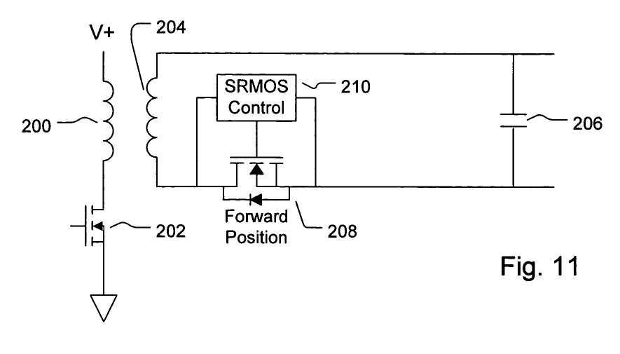

FIGS. 9-11 illustrate applications of the present invention in alternative circuit configurations. Referring to FIG. 9 illustrating a forward converter having a primary coil 160 operated by a transistor 162, a secondary coil 164 connected in series with a coil 166 and a diode 168, a SRMOS transistor 170 controlled by a SRMOS Control circuit 172 and connected in parallel with the secondary coil 164 and a capacitor 174, the SRMOS transistor is placed in the catch position of the converter circuit and it is controlled in such a manner so that it is on for the optimal maximum duration while avoiding reverse conduction. FIG. 10 illustrates another forward converter configuration having a primary coil 180 operated by a transistor 182 and a secondary coil 184 connected in series with a coil 186 and a SRMOS transistor 188 that is operated by a SRMOS Control circuit 190, and connected in parallel with a diode 192 and a capacitor 194, where the SRMOS transistor is placed in the forward position. With this configuration, the forward converter avoids reverse conduction and can be used in parallel converter applications. Referring to FIG. 11 illustrating a converter having a primary coil 200 operated by a transistor 202, a secondary coil 204 connected in series with a capacitor 206 and a SRMOS transistors 208 that is operated by a SRMOS Control circuit 210, the present invention enables the use of a SRMOS in a flyback converter where traditionally SRMOS are not easily implemented.

It is important to note that the present invention can be used in a variety of applications including periodic switching applications, and it is not limited to converters or the embodiments described herein. Furthermore, the methods described herein can be used in conjunction with prior art methods. For example, the current across the drain and source terminals of the SRMOS transistor can be sensed for reverse current flow, and the prediction methods and circuits (e.g. ramp voltage and reference voltage) of the present invention can be adapted to adjust the operation of the SRMOS so that the transistor is operated in such a manner so there is no reverse current flow in subsequent cycles. More specifically, the reference voltage can be adjusted on one hand by detecting for reverse current flow when there is reverse current flow and for Vds at a diode voltage when there is no reverse current flow but the transistor is turned off too early.

While the present invention has been described with reference to certain preferred embodiments, it is to be understood that the present invention is not to be limited to such specific embodiments. Rather, it is the inventor's intention that the invention be understood and construed in its broadest meaning as reflected by the following claims. Thus, these claims are to be understood as incorporating and not only the preferred embodiment described herein but all those other and further alterations and modifications as would be apparent to those of ordinary skill in the art.

What I claim is:

1. A circuit for operating a transistor as a rectifier, said circuit comprising:
a transistor;
a control circuit operating said transistor as a function of the Vds voltage potential of said transistor and an indication signal during a particular cycle.

2. A circuit as recited in claim 1 wherein said indication signal is the on-time or off-time duration of said Vds voltage potential in a previous cycle and the on-time and off-time duration of a subsequent cycle is adjusted as a function of said on-time duration of said Vds voltage potential in said previous cycle.

3. (Cancelled).

4. A circuit as recited in claim 1 wherein said indication signal is the on-time or off-time duration of said Vds voltage potential in a present cycle and the on-time and off-time duration of a subsequent cycle is adjusted as a function of said on-time duration of said Vds voltage potential in said present cycle.

5-20. (Cancelled).

21. A circuit as recited in claim 2 wherein said indication signal is the on-time or off-time duration of said Vds voltage potential in a present cycle and the on-time and off-time duration of a subsequent cycle is adjusted as a function of said on-time duration of said Vds voltage potential in said present cycle.

22. A circuit for operating a transistor as a rectifier, said circuit comprising:
a transistor;
a control circuit operating said transistor as a function of the Vds current of said transistor and an indication signal during a particular cycle.

23. A circuit as recited in claim 22 wherein said indication signal is the on-time or off-time duration of said Vds current in a previous cycle and the on-time and off-time duration of a subsequent cycle is adjusted as a function of said on-time duration of said Vds current in said previous cycle.

24. A circuit as recited in claim 22 wherein said indication signal is the on-time or off-time duration of said Vds current in a present cycle and the on-time and off-time duration of a subsequent cycle is adjusted as a function of said on-time duration of said Vds current in said present cycle.

25. A circuit as recited in claim 23 wherein said indication signal is the on-time or off-time duration of said Vds current in a present cycle and the on-time and off-time duration of a subsequent cycle is adjusted as a function of said on-time duration of said Vds current in said present cycle.

26. A method for operating a transistor as a rectifier, comprising the steps of:
detecting the Vds signal of a transistor; and
operating said transistor as a function of the Vds voltage potential of said transistor and an indication signal during a particular cycle.

27. A method as recited in claim 26 wherein said indication signal is the on-time or off-time duration of the Vds voltage potential in a previous cycle and the on-time and off-time duration of a subsequent cycle is adjusted as a function of said on-time duration of said Vds voltage potential in said previous cycle.

28. A method as recited in claim 26 wherein said indication signal is the on-time or off-time duration of the Vds voltage potential in a present cycle and the on-time and off-time duration of a subsequent cycle is adjusted as a function of said on-time duration of said Vds voltage potential in said present cycle.

29. A circuit as recited in claim 27 wherein said indication signal is the on-time or off-time duration of the Vds voltage potential in a present cycle and the on-time and off-time duration of a subsequent cycle is adjusted as a function of said on-time duration of said Vds voltage potential in said present cycle.

30. A method for operating a transistor as a rectifier, comprising the steps of:
detecting the Vds signal of a transistor; and
operating said transistor as a function of the Vds current of said transistor and an indication signal during a particular cycle.

31. A circuit as recited in claim 30 wherein said indication signal is the on-time or off-time duration of said Vds current in a previous cycle and the on-time and off-time duration of a subsequent cycle is adjusted as a function of said on-time duration of said Vds current in said previous cycle.

32. A circuit as recited in claim 30 wherein said indication signal is the on-time or off-time duration of said Vds current in a present cycle and the on-time and off-time duration of a subsequent cycle is adjusted as a function of said on-time duration of said Vds current in said present cycle.

33. A circuit as recited in claim 31 wherein said indication signal is the on-time or off-time duration of said Vds current in a present cycle and the on-time and off-time duration of a subsequent cycle is adjusted as a function of said on-time duration of said Vds current in said present cycle.
